(19) United States
(12) Patent Application Publication
(10) Pub. No.: US 2026/0360605 A1
(43) Pub. Date: Nov. 12, 2026

(54) INDUCTION DEVICE, IN PARTICULAR FOR AN ELECTRODYNAMIC BRAKE, AND ELECTRODYNAMIC BRAKE

(71) Applicant: Deutsches Zentrum für Luft- und Raumfahrt e.V., Köln (DE)

(72) Inventors: Christoph KÖHLER, Filderstadt (DE); Christoph HOLTMANN, Sankt Augustin (DE); Christian WEBER, Sonneberg (DE)

(73) Assignee: Deutsches Zentrum für Luft- und Raumfahrt e.V., Köln (DE)

(21) Appl. No.: 19/123,930

(22) PCT Filed: Oct. 24, 2023
(86) PCT No.: PCT/DE2023/100789

§ 371 Date: Apr. 24, 2025

(30) Foreign Application Priority Data
Oct. 25, 2022 (DE) 10 2022 128 255.4

(51) Int. Cl. H01F 27/245; H01F 27/06; H01F 27/10

(52) U.S. Cl. CPC H01F 27/245; H01F 27/06; H01F 27/10

(57) ABSTRACT

An induction device (300), in particular for an electrodynamic brake (100), having at least one support element (400) and a multiplicity of sheet units (416), wherein the multiplicity of sheet units (416) each have at least one sheet element (410), preferably a multiplicity of sheet elements (410), and the at least one support element (400) has a multiplicity of openings (402). One of the sheet units (416) is led through respectively one of the openings (402) of the at least one support element (400).

### RELATED APPLICATION

This application is a national phase of international application No. PCT/DE2023/100789 filed on Oct. 24, 2023, and claims the benefit of German application No. 10 2022 128 255.4 filed on Oct. 25, 2022, which are incorporated herein by reference in their entirety and for all purposes.

### FIELD OF DISCLOSURE

The present invention relates to an induction device, in particular for an electrodynamic brake, and to an electrodynamic brake comprising this induction device.

### BACKGROUND

Eddy-current brakes are known in the prior art. For example, DE 950 939 B discloses an eddy-current brake in which the pole cores of the inductor are arranged on both sides of an armature that is movable relative to the inductor, that is composed of one or more bodies that form the eddy-current path and have good electrical conductivity, and of parts that conduct the magnetic flux well and extend through the first-mentioned body or bodies, the parts that conduct the magnetic flux projecting on both sides beyond the body or bodies that form the eddy-current path, such that the ends of these parts form projections that improve the cooling of the armature.

Known from DE 102016108646 B4 is an electrodynamic brake comprising a magnetic device for providing a magnetic field, which has at least two pole elements and which acts in combination with an induction device. The induction device in this case is arranged in such a way that in a braking mode it is at least partially exposed to a magnetic field provided via the pole elements of the magnetic device, and is designed in such a way that electrical currents are induced in it in a variable magnetic field, the induction device and the pole elements of the magnetic device being movable relative to one another along a predefined path of movement.

With the latter electrodynamic brakes and their material structure, which is composed of steel pins and perforated sheets, it is already possible to greatly reduce the skin effect in the eddy-current brake and thereby achieve an improved current distribution. In particular, the positioning sheets that center the steel pins make it possible to significantly increase the surface area for cooling the brake, and in this way increase the power density.

### SUMMARY OF THE INVENTION

It is the object of the present invention to propose an improved electrodynamic brake that has an optimized performance and that can be produced in a simple and inexpensive manner. Furthermore, it is an object of the invention to specify an electrodynamic brake.

This object is achieved according to the invention by an induction device according to the features of claim 1 and an electrodynamic brake according to the features of claim 14. Advantageous designs are specified in the respective associated subclaims.

The object is then achieved by an induction device, in particular for an electrodynamic brake, the induction device having at least one support element and a multiplicity of sheet units. The multiplicity of sheet units each have at least one sheet element, preferably a multiplicity of sheet elements, wherein the at least one support element has a multiplicity of openings. One of the sheet units is led through, or arranged in, respectively one of the openings of the at least one support element.

The invention is based on the idea of reducing the total number of individual elements by the use of sheet elements, in particular in comparison with pins, for example, and at the same time increasing the power density within the induction device.

By reducing the number of individual elements, the manufacture time and manufacture costs may also be reduced and, for example, manufacture tolerances relaxed, i.e. designed more generously.

The compact arrangement of sheet units also results, inter alia, in an improved cooling strategy, in particular in optimized liquid cooling, with reduced dead-water areas and thus optimized heat removal.

In particular, the induction device may be designed with the greatest possible number of sheet units. In this way, torque ripple during operation of an electrodynamic brake or the like may be reduced by use of the induction device according to the invention.

The openings are preferably perpendicular to the support element, such that a theoretical central opening axis is perpendicular to the surface of the support element. Ideally, the openings are all realized so as to be identical or substantially identical.

Alternatively, the design of the openings may vary, preferably such that a symmetrical pattern is achieved along the surface of the individual support element. Accordingly, the sheet units may be realized so as to correspond to the respective opening.

For the purposes of the present invention, a sheet, in particular with regard to a sheet unit, or a sheet element, is preferably to be understood as a structure that has two comparatively longer lateral edges and one comparatively short lateral edge. In particular, the lateral edge in the direction of the thickness of the structure may be substantially shorter than the other two lateral edges, such that there is a sheet-like structure.

If the induction device has a plurality of support elements arranged one above the other, the openings of the support elements are preferably realized so as to correspond to one another. Accordingly, it is provided that the sheet units each protrude through the mutually corresponding openings of the plurality of support elements, or are arranged in them.

The support element is advantageously realized with an electrically conductive material and with a low magnetic permeability. Ideally in this case, the support elements may comprise aluminum or copper.

The sheet elements of the sheet units may advantageously be composed of a material having a high magnetic permeability, for example steel, in particular a grain-oriented or a non-grain-oriented electric sheet. The steel may be, for example, a steel of the type, or comprising the material, No. 1.0718. In this respect, for the purposes of the present invention, a sheet unit may be understood as an electric sheet stack.

Each of the sheet units may preferably comprise a plurality of sheet elements. In particular, the plurality of sheet elements of a sheet unit may bear directly against one another.

The sheet units are led through respectively one opening of the at least one support element, or arranged in this respectively one opening.

If a plurality of support elements are used, the sheet units preferably extend through respectively one opening of the plurality of support elements. Each of the sheet units is accordingly accommodated in, or protrudes through, all of the arranged support elements.

In this way, a compact and efficient induction device may be provided, which additionally allows a simplified production process and provides an improved power density.

According to a preferred embodiment, the sheet units are arranged at least substantially perpendicularly, preferably orthogonally, with respect to the support elements, and/or the sheet units are arranged in a radial direction of the induction device or with an angular offset with respect to the radial direction of the induction device.

In particular, the support elements may be oriented orthogonally in relation to a central axis of the induction device.

Preferably, the sheet units are accordingly arranged in an upright manner in the induction device in such a way that their shortest lateral edge extends parallel to the at least one support element. In this sense, the sheet elements may be understood as standing upright in the induction device.

The sheet units, or sheet elements, may also extend in a radial direction, or have an angular offset with respect to the radial direction of the induction device.

For the purposes of the present invention, the radial direction of the induction device is to be understood, in particular, as the radius of the induction device relative to the central axis.

Accordingly, if a sheet element is arranged in the radial direction, it extends in the direction from the outer circumference to the central axis/mid-point along the shortest path corresponding to the radius of the induction device.

If the sheet unit, or a sheet element, is to be arranged with an angular offset, this angular offset is to be understood as being relative to the radial direction between the outer circumference and the central axis of the induction device. In this sense, the sheet elements, or sheet units, may be arranged obliquely within the induction device.

According to a further embodiment of the present invention, the sheet units each have a plurality of sheet elements, in particular at least three sheet elements in each case, wherein the sheet elements of the individual sheet units are designed in such a way that the sheet units have an at least substantially triangular basic shape.

In particular, a plurality of sheet elements may be combined to form a sheet unit in such a way that the basic shape of the sheet unit is triangular, or at least substantially triangular.

The sheet elements of a sheet unit in this case may be realized in a stepped manner in order to achieve a triangular basic geometry. The sheet elements in the middle therefore have the greatest longitudinal extent. The outer sheet elements of a sheet unit have the shortest longitudinal extent.

In particular, the triangular basic shape of the sheet units can be used to map or replicate the narrowing in the radial direction of the induction device, such that the greatest possible, or optimum, packing density of the sheet units can be achieved.

In a preferred embodiment, the openings of the support elements with the sheet units arranged therein are realized in relation to one another in such a way that interspaces are realized between the mutually adjacently arranged sheet units, wherein the interspaces are preferably provided, or realized, as flow channels for a cooling fluid, or coolant.

In particular, a good cooling and through-flow capability can be ensured so that, with a high/strong induction, the energy converted into heat can be dissipated.

In particular, it is provided that the cooling fluid can circulate between the sheet units within the induction device.

The cooling fluid may follow a radial flow direction in order to ensure heat removal for the purpose of cooling the compact sheet units, or sheet elements.

Preferably, the cooling fluid may be a cooling liquid, or a liquid cooling system. Alternatively, for the purposes of the present invention, air cooling may be used.

According to a further preferred embodiment, the wall element at the outer diameter of the induction device may be surrounded by an outer housing, wherein the outer housing has at least one opening for a cooling fluid, and the wall element at the outer diameter of the induction device has at least one pass-through opening for a cooling fluid. A flow channel may preferably be realized, in at least some sections, in a circumferential direction between the outer housing and the wall element at the outer diameter of the induction device.

In particular, for the purpose of cooling the sheet units, a cooling fluid may be introduced into the induction device from outside, via the opening of the outer housing and the pass-through opening of the wall element, at an outer diameter, or in the region of an outer diameter, of the induction device.

The cooling fluid may flow through the induction device between the sheet units and between the support elements, preferably in a radial direction. In particular, a bidirectional through-flow in the radial direction may be provided, i.e. an inflow of cooling fluid in the direction of the inner/outer diameter, and an outflow in the direction of the outer/inner diameter of the induction device.

Furthermore, it may preferably be provided that a gap, or a flow channel, is realized between the outer housing and the wall element at/in the region of the outer diameter of the induction device, at least in some sections along the circumferential direction.

Thus, a coolant, or a cooling fluid, may be distributed in the circumferential direction (at least in some sections) and passed on, through the pass-through opening of the wall element, to the sheet units in order to flow along the sheet units in a radial direction and enable heat to be removed.

According to a further embodiment, the wall element has, at the inner diameter of the induction device, at least one deflection portion for deflecting the cooling fluid in preferably a radial direction.

In this way, the cooling fluid may flow into the induction device in, in particular, a radial direction, flow to the inner diameter of the induction device, be deflected by the wall element at the inner diameter and flow back in a radial direction to the outer diameter of the induction device.

In this way, in particular, a cooling circuit may be realized within the induction device.

According to a further embodiment, the induction device has a wall element at an inner diameter and/or at an outer diameter.

In particular, the at least one support element and the sheet units may be surrounded by the wall elements in such a way that a fixed positioning of the components is ensured.

The radially outer wall element may also have openings for the entry of a cooling fluid.

According to an embodiment, the at least one wall element of the induction device has retaining web recesses, wherein the sheet units, in particular the individual sheet elements, have retaining web portions at an outer diameter and/or an inner diameter, wherein the retaining web recesses and the retaining web portions are provided for mutual engagement in one another.

In this way, the sheet units may be accommodated and fastened between the wall elements, preferably without additional fastening means or the like. The sheet units and the wall elements may be such that they can be integrally interlocked with one another.

According to a preferred embodiment, at least some of the sheet elements of a sheet unit bear with contact against the support element.

This means that, in particular, the outer sheet elements of a sheet unit, or their outer faces, bear with contact against one of the opening edges of the opening, such that support may be effected in this way. In the case of a sheet element preferably realized as a rectangle, and a straight opening edge, geometries may therefore touch one another on a contact line.

In the case of the sheet units being of a triangular basic shape, a plurality of sheet units may alternatively bear in a localized manner against the support element points.

Preferably, the openings, or the opening edge(s) of the openings, are realized in the manner of a stepped edge/step shape, such that the opening, or opening edge, follows the preferably stepped outer contour of the sheet unit. In this case, the sheet unit may preferably be supported along a continuous line of contact with the respective opening, or opening edge.

According to an embodiment, at least some of the sheet elements have an electrically insulating material as a deposit, or are covered with a lamination, in particular have a phosphate-containing material as a deposit.

In order to avoid short-circuits and optimize the formation of magnetic field lines, a further improvement may therefore be that at least some of the sheet elements have an electrically insulating material on the outer surface. This may be a deposit, such as a phosphate coating, or another electrically insulating lamination, or an electrically insulating coating, in particular an insulating varnish for an electric sheet (stack).

In particular, the sheet units as a whole may be provided with such a lamination, or coating.

According to a preferred embodiment, a return element is provided, which is preferably made of a soft magnetic composite or of a ceramic ferrite, in particular an iron-containing return element.

For the subsequent installation of the induction device with a single-sided magnetic device, an improved embodiment may therefore be that a return element is provided that is preferably made of a soft magnetic composite or of a ceramic ferrite, realized, in particular, as an iron-containing return element.

This return element may form an end element, and is in the form, for example, of a plate or a ring.

In particular, the return element may be provided at an end of the induction device, or of the sheet units. The return element may also be in physical contact with an end of the sheet units.

When fitted, the return element is preferably arranged on the side of the induction device that faces away from the poles, or pole shoes. The return element is preferably realized parallel to the support elements.

For the purposes of the present invention, in particular, various return and/or exciter variants may be provided, as known, for example, from DE 10 2016 108 646 B4.

For example, a disk-shaped return element may be provided, or a helically wound steel strip to form a disk-shaped return element.

The excitation coils, or pole elements, may also be arranged, for example, on one side of the induction device or, by replacing the return element, on both sides. The excitation coils, or pole elements, may be realized as north poles only, or the pole elements may be provided in the form of permanent magnets instead of as core-wound coils. In particular, if the pole elements are arranged on both sides, it may be that only north poles, or south poles, are arranged on one side of the respective carrier plate.

For the purposes of the present invention, the pole elements may in particular be provided as a rotor, and the induction device may preferably be provided as a stator.

According to a further embodiment, there is at least one spacer, in particular in the form of a silicone cord, a plastic cord, a silicone ring, a plastic ring or the like, or in the form of an intermediate element having a tangential wave contour, arranged between two adjacently arranged support elements of the plurality of support elements, such that a minimum spacing is provided between two adjacently arranged support elements.

For this purpose, there may one or more flexible spacers arranged between two support elements, such as, for example, one or more silicone cords. In particular, silicone or plastic rings, on or against which a subsequent support element can bear, may also be placed around, or onto, the sheet units. Advantageously, the mutually superimposed support elements provide an open structure that allows through-flow.

Alternatively, an intermediate element, or an intermediate sheet, having a tangential wave contour/shape may be inserted between the support elements in order to provide a spacing, or a minimum spacing, between the support elements.

According to a further preferred embodiment, the induction device has at least one cover element, in particular at least one cover sheet, that is provided at an end of the induction device, wherein the cover element has an electrical conductivity that is lower than the electrical conductivity of the at least one support element.

For example, the cover element may comprise a material such as high-grade steel or the like.

Furthermore, the cover element, or cover sheet, may preferably be arranged in contact with the wall elements and/or the sheet units.

Preferably, the at least one cover element is provided on the induction device in such a way that the cover element realizes a fluid-tight connection to the wall elements and/or the sheet units.

In particular, the cover element may be provided on a side of the induction device that is opposite to the return element.

If pole elements, or coils, are provided on both sides of the induction device, the induction device may be realized with two cover elements, with respectively one cover element being arranged at, or in the region of, one end of the induction device, to form a preferably fluid-tight arrangement.

In particular, the at least one cover element may have openings that correspond to the openings of the support elements, such that the sheet units may protrude, or do protrude, through the at least one cover element.

Preferably, the connection, or contact point, between the individual sheet units and the at least one sheet unit may be realized in a fluid-tight manner.

Preferably, the electrical conductivity of the cover element is as low as possible.

Since the cover element has a low electrical conductivity, the sheet units can be protected from additional heat input.

The invention additionally includes an electrodynamic brake, which has a magnetic device for providing a magnetic field. The magnetic device preferably has at least one pole element, and an induction device according to the present invention.

Preferably, the induction device may be arranged in such a way that in a force mode it is at least partially exposed to a magnetic field provided via the pole elements of the magnetic device, and wherein the induction device and the pole elements of the magnetic device are movable relative to one another along a predefined path of movement.

In this way, an efficient electrodynamic brake is provided, which may be produced by means of a simplified and inexpensive process.

Further details and advantages of the invention will now be explained in more detail with reference to exemplary embodiments represented in the drawings.

### BRIEF DESCRIPTION OF THE DRAWINGS

FIG. 1 shows a perspective view of an electrodynamic braking device having an induction device;

FIG. 2 shows a top view of an exemplary embodiment of an induction device;

FIG. 3 shows a top view of a further exemplary embodiment of an induction device;

FIG. 4 shows a sectional representation of an exemplary embodiment of an induction device according to FIG. 2;

FIG. 5 shows a detail view of the induction device according to an exemplary embodiment;

FIG. 6 shows a perspective representation of the sheet units of the exemplary embodiment according to FIG. 2; and FIG. 7 shows a detail representation of an exemplary embodiment of an induction device.

### DETAILED DESCRIPTION OF THE DRAWINGS

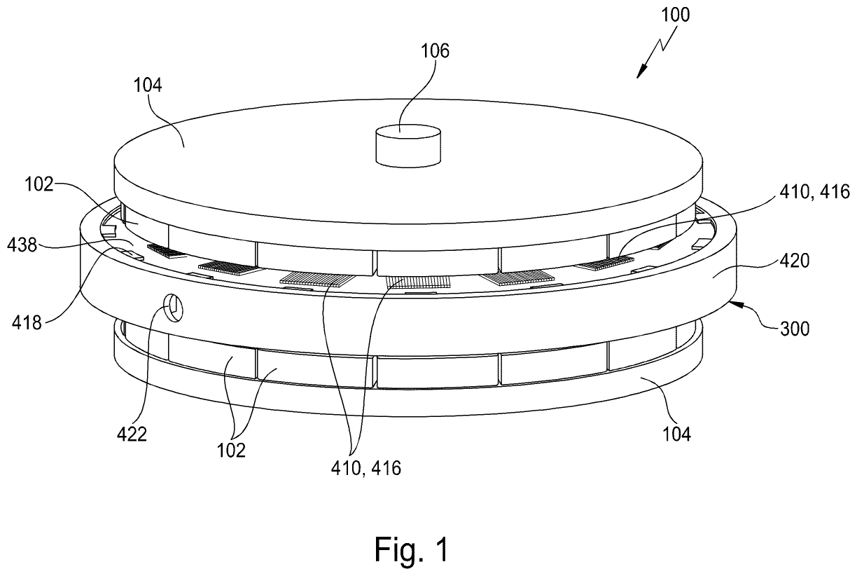

FIG. 1 shows an exemplary embodiment of an electrodynamic brake 100 having an induction device 300.

The electrodynamic brake 100 is arranged on a shaft 106.

The shaft 106, or a longitudinal axis of the shaft 106, may be understood as the axis of rotation of the electrodynamic brake 100.

Arranged on both sides of the induction device 300 there is plurality of pole elements 102, as shown in FIG. 1.

The pole elements 102 on a respective side of the induction device 300 may preferably have alternating polarities.

Furthermore, the pole elements 102 are each provided with an end plate 104.

As shown in FIG. 1, the induction device 300 is realized with a multiplicity of sheet units 416, each of which has a plurality of sheet elements 410.

The multiplicity of sheet units 416 is arranged radially (evenly) distributed around the axis of rotation, or axis of symmetry, of the electrodynamic brake 100, or of the induction device 300.

In particular, the sheet elements 410 of each sheet unit 416 are arranged so as to be directly adjacent to one another.

Furthermore, the induction device 300 has a cover element 438.

The cover element 438 is shown with openings, through which the sheet units 416 protrude.

At an outer diameter, or in the region of an outer diameter, the induction device 300 has a wall element 418.

The wall element 418 is surrounded by an outer housing 420. The outer housing may have an opening 422 for a cooling fluid, as shown in FIG. 1.

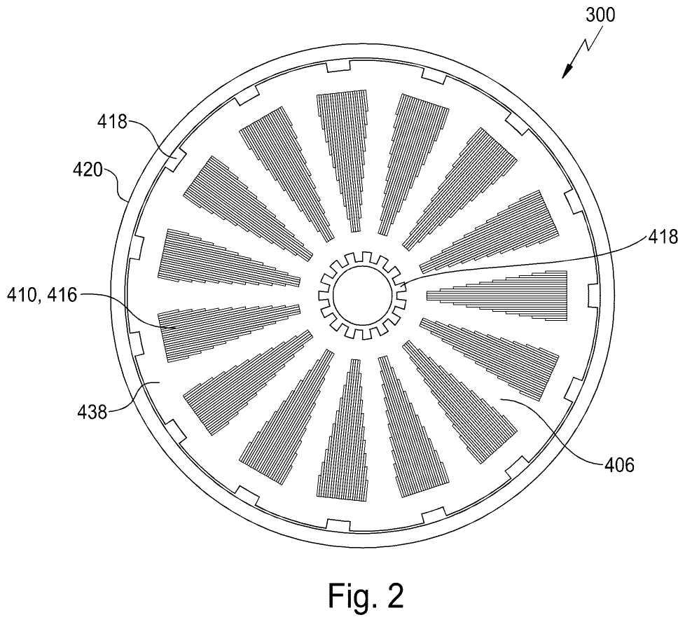

FIG. 2 shows a top view of an exemplary embodiment of an induction device 300.

The multiplicity of sheet units 416 is represented with an even radial distribution along the induction device 300.

The sheet units 416 are oriented in a radial direction, such that a longitudinal axis of the respective sheet units 416 extends from a circumference to a mid-point of the induction device 300.

The sheet units 416, each having a plurality of sheet elements 410, have an at least substantially triangular basic shape.

In particular, the sheet units 416 are shown with a stepped configuration of the individual sheet elements 410, such that the sheet units have a substantially triangular basic geometry.

The sheet elements 410 protrude through openings in the cover element 438.

Between the sheet units 416 of the sheet elements 410, or the openings, the cover element 438 may be realized with webs 406, or comprise webs 406.

Adjacently arranged sheet units 416 are arranged with a mutual spacing, so as to realize interspaces 412.

The wall element 418 is provided at an outer diameter of the induction device 300, surrounded by the outer housing 420.

In particular, the wall element 418 may encompass the cover element 438 in some sections, or engage in the cover element 438.

At an inner diameter, the induction device 300 has a further wall element 418.

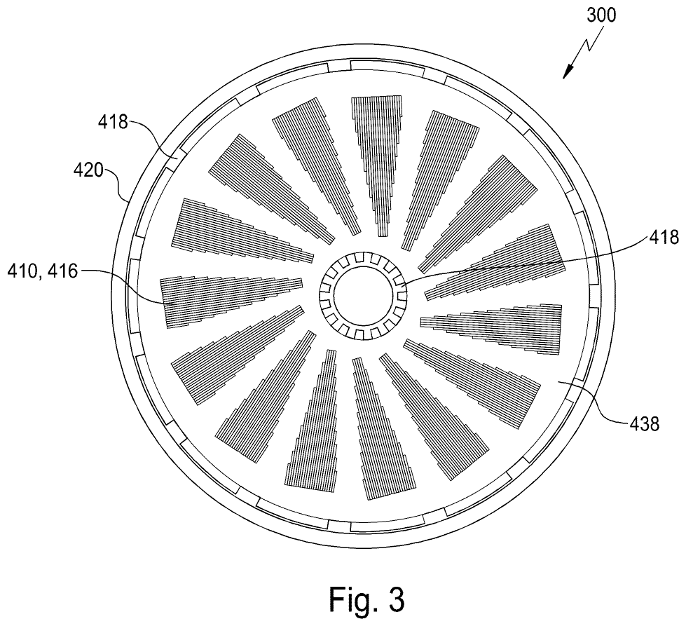

Represented in FIG. 3 is a top view of a further exemplary embodiment of an induction device 300.

The exemplary embodiment according to FIG. 3 differs from the exemplary embodiment according to FIG. 2, in particular, in the orientation, or arrangement, of the sheet units 416. As shown in FIG. 3, the sheet units 416 are rotated, or arranged obliquely, with respect to a radial direction.

The sheet units 416, each having a plurality of sheet elements 410, or the longitudinal axis of the respective sheet unit 416, have, or has, an angular offset with respect to the radial direction of the induction device 300.

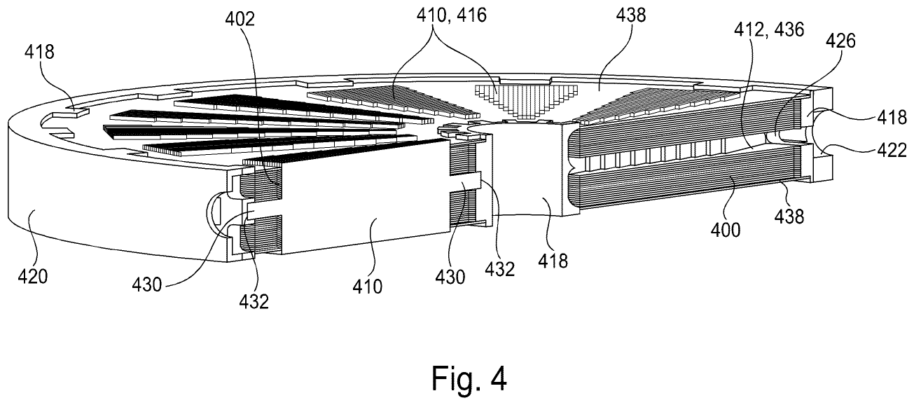

FIG. 4 shows a sectional representation of an exemplary embodiment of an induction device 300 shown in FIG. 2.

As shown in FIG. 4, the induction device 300 has a plurality of support elements 400 arranged one above the other.

The support elements 400 are realized with openings 402, the sheet units 416 each protruding through corresponding openings 402 of the plurality of support elements 400.

In particular, the sheet units 416 may bear against the opening edges of the openings 402 of the support elements 400.

Preferably, the support elements 400 are arranged with a mutual spacing, so as to realize interspaces 412.

Spacings between the support elements 400 may be achieved, for example, by spacers such as a plastic ring, e.g. a silicone ring, a plastic cord or by means of an arranged intermediate sheet having a tangential wave contour.

As shown in FIG. 4, the individual sheet elements 410 of the sheet units 416 have retaining web portions 430, preferably at an inner diameter and an outer diameter.

The inner and outer wall elements 418 (at an inner diameter and outer diameter, respectively, of the induction device 300) are realized with corresponding retaining web recesses 432, such that the retaining web portions 430 can engage in the retaining web recesses 432, in particular such that the sheet units can be, or are, interlocked in the wall elements.

Furthermore, as shown in FIG. 4, due to the retaining web portions 430, realized between a plurality of support elements 400 there is an interspace 412, which can be used as a flow channel 436 for a cooling fluid.

The wall element 418 may have a pass-through opening 426 for the cooling fluid, which is preferably designed so as to correspond to, or overlap with, the opening 422 of the surrounding outer housing 420.

A cooling fluid can enter the interspaces 412, or the flow channels 436, via the opening 422 of the outer housing and the pass-through opening 426 of the outer wall element 418, and flow through the induction device 300 in a radial direction.

Furthermore, a cover element 438 is provided on both sides of the induction device 300.

Preferably, the cover element 438 is arranged in a fluid-tight manner on the wall elements 418 and the sheet units 416.

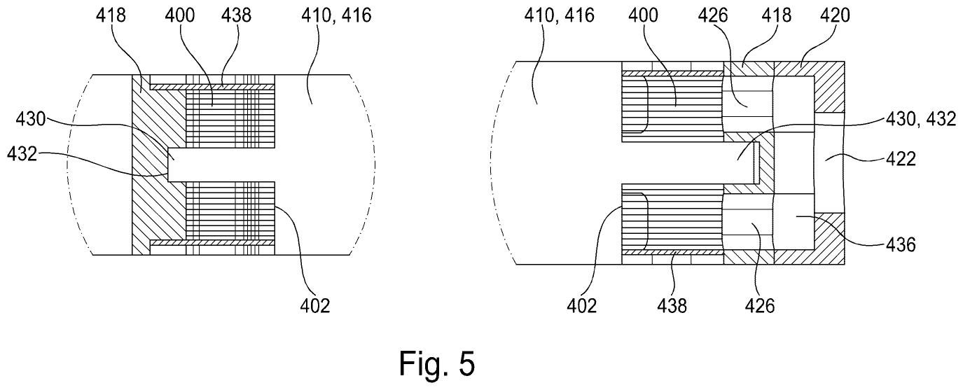

Represented in FIG. 5 is a detail view of the induction device 300 according to an exemplary embodiment.

As shown in FIG. 5, it may be provided that the pass-through opening 426 of the outer wall element 418 is at least partially offset vertically, in particular above and/or below the retaining web recess 432, with respect to the opening 422 of the outer housing 420.

A gap, or a flow channel 436, along which a cooling fluid can flow in the circumferential direction, at least in some sections, may be realized between the outer housing 420 and the outer wall element 418.

Furthermore, it can be seen from FIG. 5 that the sheet units 416 are enclosed in contact with the openings 402 of the support elements 400 and the openings of the cover elements 438, in particular with a precise fit, and protrude through these.

The cover elements 438 are designed to close off the induction device 300 in a fluid-tight manner on an upper side and an underside.

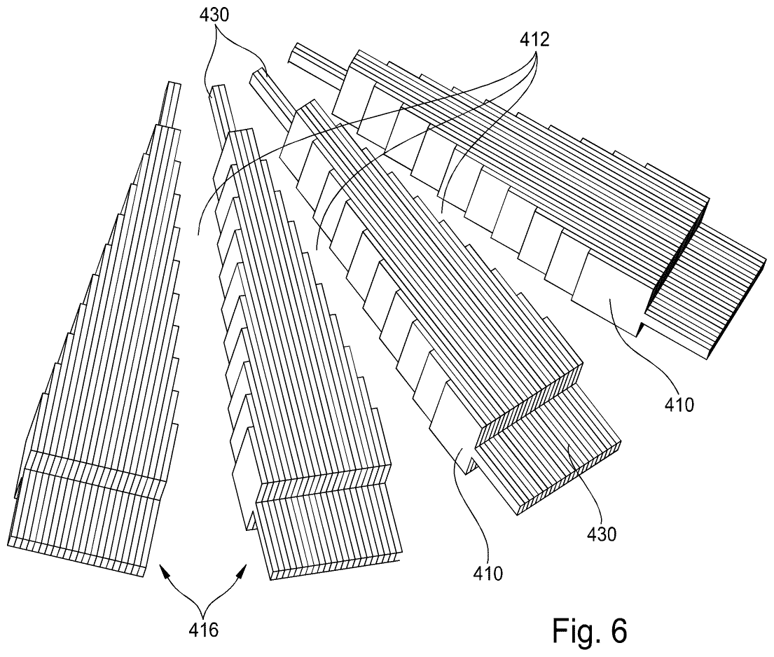

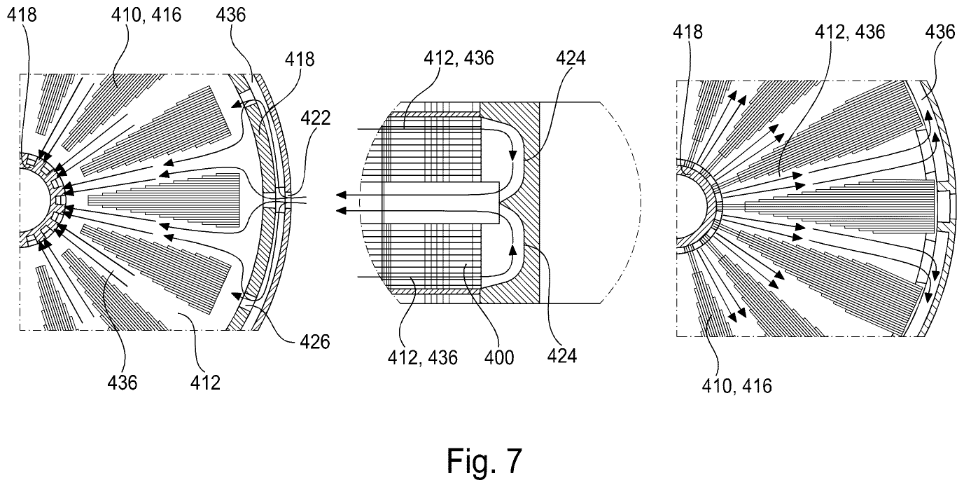

FIG. 6 shows a perspective representation of the sheet units of the exemplary embodiment according to FIG. 2.

In particular, the retaining web portions 430 of the sheet units 416, or the individual sheet elements 410, are visible.

The retaining web portions 430 are provided on an outer side and on an inner side of the sheet units 416, for interlocking, or engaging, in corresponding retaining web recesses 432 of the wall elements 418.

Furthermore, the sheet units 416 have an at least substantially triangular basic shape, which is achieved in particular by a stepped design of the individual sheet elements 410.

The sheet units 416 are oriented with their respective longitudinal axis in a radial direction, such that the longitudinal axes intersect at a mid-point, or an axis of rotation (of the electrodynamic brake 100, or of the induction device 300).

In addition, the mutually adjacently arranged sheet units 416 are spaced apart from one another, such that interspaces 412 can be/are realized.

FIG. 7 shows a detailed representation of an exemplary embodiment of an induction device 300.

In particular, the direction of flow of a cooling fluid is indicated in FIG. 7 by means of an arrow.

As shown in FIG. 7, the inner wall element 418 may have deflection portions 424 for deflecting the cooling fluid flow, preferably by 180° in a radial direction.

In particular, the various interspaces 412 between the sheet units 416 and between the support elements 400 may be used to allow bidirectional flowing of the cooling fluid in a radial direction, such that a cooling circuit may be provided within the induction device 300.

Preferably, as shown in FIG. 7, the cooling fluid may flow radially inward between the support elements 400, be deflected by the wall element 418 at the inner diameter of the induction device 300, or by the deflection portions 424, and flow back radially outward, centrally between the support elements, in particular in an interspace 412 realized by the retaining web portions 430.

It is also represented in FIG. 7 that a gap, or flow channel 436, may be provided between the outer housing 420 and the outer wall element 418.

The cooling fluid may flow between the outer housing 420 and the outer wall element 418, at least in some sections, in the circumferential direction.

In particular, the cooling fluid that enters through the opening 422 of the outer housing 420 may be distributed in a circumferential direction, and flow onward through a plurality of pass-through openings 426 of the outer wall element 418.

The interspaces 412, or flow channels 436, are preferably realized in such a way that the cooling fluid can flow through the induction device 400, with the sheet units 416 and the support elements 400, primarily in a radial direction.

Overall, it is understood in the context of the present invention that the indications relating to gravity, such as “up”, “down”, “lower”, “place on”, “upright”, “hanging”, etc., serve only to illustrate and describe the elements represented in a particular position. These indications are not to be understood as limiting with regard to the orientation of the induction device in use or during assembly, and ensue analogously in the case of a different orientation, such as a vertical orientation of the induction device.

In summary, by means of the sheet units 416, the present invention constitutes an efficient induction device 300 that, in particular, may have, or provide, a high power density.

Furthermore, the induction device 300 according to the invention constitutes an optimized cooling strategy for the transport of heat, or removal of heat, by means of a selective, at least substantially radial coolant flow, or flow of cooling fluid.

In addition, the induction device 300 enables simplified production, in particular with regard to the number of individual components and their handling, the manufacturing tolerances and the resulting shorter assembly times.

### List of reference designations

100 brake
102 pole element
104 end plate
106 shaft
300 induction device
400 support element
402 opening
406 web
410 sheet element
412 interspace
416 sheet unit
418 wall element
420 outer housing
422 opening (outer housing)
424 deflection portion (wall element)
426 pass-through opening (wall element)
430 retaining web portions
432 retaining web recesses
436 flow channel
438 cover element

1. An induction device, optionally for an electrodynamic brake, the induction device comprising:
at least one support element; and a multiplicity of sheet units,
wherein the multiplicity of sheet units each have at least one sheet element, or a multiplicity of sheet elements,
wherein the at least one support element has a multiplicity of openings, and
wherein one of the sheet units is led through respectively one of the openings of the at least one support element.

2. The induction device as claimed in claim 1,
wherein
the sheet units are arranged at least substantially perpendicularly, or orthogonally, with respect to the support elements, and/or the sheet units are arranged in a radial direction of the induction device or with an angular offset with respect to the radial direction of the induction device.

3. The induction device as claimed in claim 1,
wherein
the sheet units each have a plurality of sheet elements, optionally at least three sheet elements in each case, wherein the sheet elements of the individual sheet units are designed in such a way that the sheet units have an at least substantially triangular basic shape.

4. The induction device as claimed in claim 1,
wherein
the openings of the support elements with the sheet units arranged therein are realized in relation to one another in such a way that interspaces are realized between the mutually adjacently arranged sheet units, a
wherein the interspaces are preferably provided as flow channels for a cooling fluid.

5. The induction device as claimed in claim 1,
wherein
the induction device has a wall element at an inner diameter and/or at an outer diameter.

6. The induction device as claimed in claim 5,
wherein
the wall element at the outer diameter of the induction device is surrounded by an outer housing,
wherein the outer housing has at least one opening for a cooling fluid, and the wall element at the outer diameter of the induction device has at least one pass-through opening for a cooling fluid, and wherein a flow channel is preferably realized, in at least some sections, in a circumferential direction between the outer housing and the wall element at the outer diameter of the induction device.

7. The induction device as claimed in claim 5,
wherein
the wall element has, at the inner diameter of the induction device, at least one deflection portion for deflecting the cooling fluid in preferably a radial direction.

8. The induction device as claimed in claim 5,
wherein
the at least one wall element of the induction device has retaining web recesses,
wherein the sheet units, optionally the individual sheet elements, have retaining web portions at an outer diameter and/or an inner diameter, and
wherein the retaining web recesses and the retaining web portions are provided for mutual engagement in one another.

9. The induction device as claimed in claim 1,
wherein
at least some of the sheet elements of a sheet unit bear with contact against the support element.

10. The induction device as claimed in claim 1,
wherein
at least some of the sheet elements have an electrically insulating material as a deposit, or are covered with a lamination, optionally have a phosphate-containing material as a deposit.

11. The induction device as claimed in claim 1,
wherein
a return element is provided, which is preferably made of a soft magnetic composite or of a ceramic ferrite, optionally an iron-containing return element.

12. The induction device as claimed in claim 1,
wherein
there is at least one spacer, optionally in the form of a silicone cord, a plastic cord, a silicone ring, a plastic ring or the like, or in the form of an intermediate element having a tangential wave contour, arranged between two adjacently arranged support elements of the plurality of support elements, such that a minimum spacing is provided between two adjacently arranged support elements.

13. The induction device as claimed in claim 1,
wherein
the induction device has at least one cover element, optionally at least one cover sheet, that is provided at an end of the induction device, and
wherein the cover element has an electrical conductivity that is lower than the electrical conductivity of the at least one support element.

14. An electrodynamic brake having a magnetic device, for providing a magnetic field, which has at least one pole element, and an induction device according to claim 1.
